(19) United States
(12) Patent Application Publication
(10) Pub. No.: US 2022/0003848 A1
(43) Pub. Date: Jan. 6, 2022

(54) RANGE FINDING APPARATUS

(71) Applicant: DENSO CORPORATION, Kariya-city (JP)

(72) Inventor: Masahiro YAMAMOTO, Kariya-city (JP)

(21) Appl. No.: 17/479,445

(22) Filed: Sep. 20, 2021

Related U.S. Application Data
(63) Continuation of application No. PCT/JP2020/009406, filed on Mar. 5, 2020.

(30) Foreign Application Priority Data
Mar. 22, 2019 (JP) 2019-055030

(51) Int. Cl. G01S 7/481; G01S 17/931

(52) U.S. Cl. CPC G01S 7/4817; G01S 17/931

(57) ABSTRACT

A heater is disposed on an inner surface or an outer surface of a transmission window to cover a transmission region where at least either the transmission waves or the reflected waves pass through and a circuit component is disposed on the inner surface or the outer surface of the transmission window, in a region other than a region where the heater is disposed.

### CROSS-REFERENCE TO RELATED APPLICATION

This application is the U.S. bypass application of International Application No. PCT/JP2020/009406 filed on Mar. 5, 2020, which designated the U.S. and claims priority to Japanese Patent Application No. 2019-055030, filed Mar. 22, 2019, the contents of both of these are incorporated herein by reference.

### BACKGROUND

### Technical Field

The present disclosure relates to a range finding apparatus.

### Description of the Related Art

As a range finding apparatus mounted on a vehicle for measuring a distance to an object existing ahead of the vehicle, an apparatus is known in which transmission waves are irradiated towards the front and reflected waves are received from an object that reflects the emitted transmission waves, thereby measuring the distance to the object.

### SUMMARY

The present disclosure provides a range finding apparatus for measuring a distance to an object including a detection module, a housing, a transmission window, a heater and a circuit component. The detection module includes an irradiation unit that irradiates transmission waves scanned in a scanning direction set in advance, and a detection unit that detects reflected waves of an object arriving from a scanning range. The housing accommodates the detection module. The transmission window is a part of the housing and provided facing the detection module, allowing the transmission waves and the reflected waves to transmit therethrough. The heater heats the transmission window. The circuit component is used for the range finding apparatus.

### BRIEF DESCRIPTION OF THE DRAWINGS

In the accompanying drawings:

FIG. 1 is a perspective view showing an appearance of a LIDAR apparatus;

FIG. 2 is a perspective view showing a configuration of a detection module;

FIG. 3 is a schematic diagram showing a configuration inside a housing when viewed from a front side thereof;

FIG. 4 is a perspective view showing a configuration of a cover;

FIG. 5 is a diagram showing a configuration of an inside the cover;

FIG. 6 is a diagram showing a film substrate;

FIG. 7 is a diagram showing a cleaning machine provided in the LIDAR apparatus; and

FIG. 8 is a diagram showing a configuration of the inside the cover according to another embodiment.

### DETAILED DESCRIPTION OF PREFERRED EMBODIMENTS

As a range finding apparatus mounted on a vehicle for measuring a distance to an object existing ahead of the vehicle, an apparatus is known in which transmission waves are irradiated towards the front and reflected waves are received from an object that reflects the emitted transmission waves, thereby measuring the distance to the object.

The range finding apparatus generally includes a housing in which an irradiation unit that irradiates transmission waves and a detection unit that detects reflected waves are accommodated. In the front part of the housing, a transmission window is provided to allow the transmission waves and the reflected waves to transmit therethrough.

However, in the case where snow, rainwater or the like is adhered to the transmission window, the measurement accuracy of the range finding apparatus may be lowered.

In this respect, Japanese Translation of PCT international Application Publication No. 2015-506459 discloses a transmission window provided with a heater for heating the transmission window to eliminate snow, rainwater or the like adhered thereto.

Hereinafter, with reference to the drawings, an exemplary embodiment according to the present disclosure will be described.

### 1. Overall Configuration

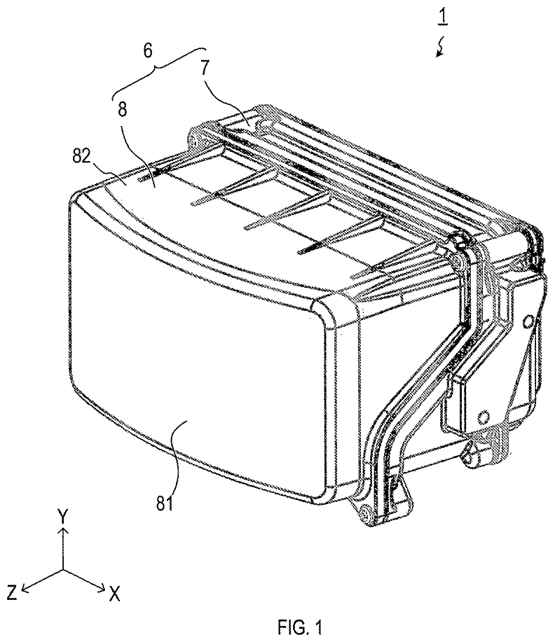

A LIDAR apparatus 1 shown in FIG. 1 serves as a range finding apparatus in which light is irradiated as transmission waves and reflected waves of the irradiated light are detected, thereby measuring the distance to an object. Note that LIDAR is an abbreviation of Light Detection and Ranging. The LIDAR apparatus 1 is mounted on a vehicle and used for detecting various objects existing ahead of the vehicle.

As shown in FIG. 1, the LIDAR apparatus 1 is provided with a housing 6. The housing 6 is a resin-made box shaped body formed in a rectangular parallelopiped shape.

The housing 6 is provided with a housing body 7 and a cover 8. A transmission window 81 as a part of the cover 8 is provided in a front side of the cover 8, allowing the transmission waves and the reflected waves to pass therethrough. Note that the front side refers to a direction to which the transmission waves are irradiated.

Hereinafter, in the case where the LIDAR apparatus 1 is mounted on a vehicle or the like, a left-right direction when the transmission window 81 is viewed from the front side is referred to as X-axis direction, a vertical direction when the transmission window 81 is viewed from the front side is referred to as Y-axis direction, a direction orthogonal to the X-Y plane is referred to as Z-axis direction. The Z-axis direction is also referred to as front-back direction of the housing 6.

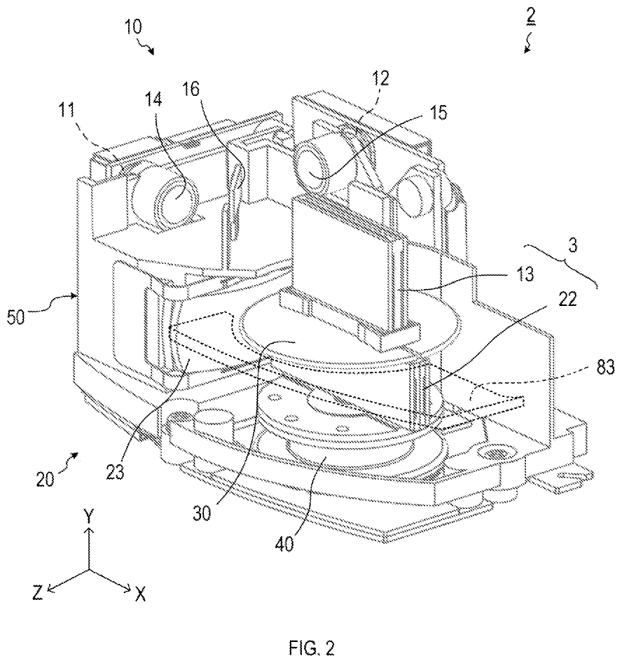

In the housing 6, a detection module 2 shown in FIG. 2 is accommodated therein. The detection module 2 is attached to the housing body 7 via a frame 50 constituted of a plurality of components.

Hereinafter, a configuration of the detection module 2, a configuration of the cover 8 and especially a configuration of inside the cover 8 will be described in detail.

### 2. Configuration of Detection Module

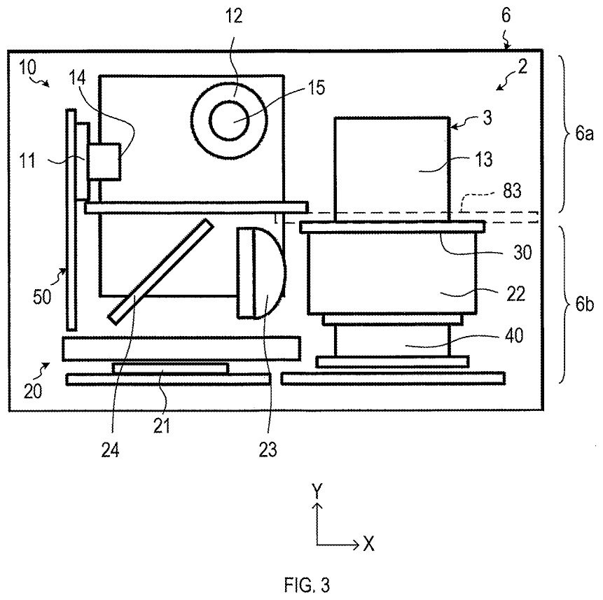

As shown in FIGS. 2 and 3, the detection module 2 includes an irradiation unit 10, a detection unit 20, an intermediate plate 30 and a motor 40. Note that illustration of some components in the frame 50 are omitted in order to easily recognize the configuration of the detection module 2.

Hereinafter, the configuration of the detection module 2 will be described in detail.

[2-1. Irradiation Unit]

The irradiation unit 10 is accommodated in an upper space inside the housing 6, and configured to irradiate light which is scanned in a scanning direction set in advance.

As shown in FIG. 2, the irradiation unit 10 is provided with a pair of light sources 11 and 12, and an irradiation mirror 13. The irradiation unit 10 may be provided with a pair of irradiation side lenses 14 and 15, and an irradiation side return mirror 16.

For the light sources 11 and 12, semiconductor laser is used for both light sources 11 and 12.

The irradiation mirror 13 is a plate-like member in which a pair of deflecting mirrors that reflect light are attached to the both sides of thereof. The irradiation mirror 13 rotates around a rotational axis along the Y-axis direction when driving the motor 40 which will be described later.

The irradiation side lens 14 is disposed facing the emission surface of the light source 11. Similarly, the irradiation lens 15 is disposed facing the emission surface of the light source 12.

The irradiation side return mirror 16 is configured to change the travel direction of the light.

The light source 11 is disposed such that the light emitted from the light source 11 passes through the irradiation side lens 14 and is directly incident on the irradiation mirror 13.

The light source 12 and the irradiation side return mirror 16 are arranged such that the light emitted from the light source 12 passes through the irradiation side lens 15, the travel direction thereof is changed by approximately 90 degrees at the irradiation side return mirror 16, and is incident on the irradiation mirror 13.

Here, the light source 11 is disposed in the left side of the housing 6 so as to output the light towards the right side, and the light source 12 is disposed in the rear side of the housing 6 so as to output the light towards the front side. The irradiation side return mirror 16 is disposed not to disturb the path of the light proceeding towards the irradiation mirror 13 from the light source 11.

The irradiation unit 10 is configured to irradiate light by operating in the following manner. The light emitted from the light source 11 is incident on the irradiation mirror 13 via the irradiation side lens 14. Further, the light emitted from the light source 12 passes through the irradiation side lens 15, thereafter the travel direction of the light is changed by approximately 90 degrees, and the light is incident on the irradiation mirror 13. The light incident on the irradiation mirror 13 is emitted in a direction depending on the rotational angle of the irradiation mirror 13 through the transmission window 81. A range where the light is irradiated via the irradiation mirror 13 is defined as a scanning range. For example, a range of +/−60 degrees spreading in the X-axis direction where a front direction along the Z-axis direction is defined as 0 degree may be set to be a scanning range.

[2-2. Detection Unit]

The detection unit 20 is accommodated in the lower space inside the housing, and is configured to detect reflected waves of an object arriving from the scanning range.

The detection unit 20 is provided with a light receiving element 21 and a detection mirror 22. The detection unit 20 may be provided with a detection side lens 23 and a detection side return mirror 24. The light receiving element 21 includes an APD array in which a plurality of APDs are arranged in a row. Note that APD is an abbreviation of Avalanche Photo Diode.

Similar to the irradiation mirror 13, the detection mirror 22 is a plate-like member in which a pair of deflecting mirrors that reflect light are attached to the both sides thereof. Also, similar to the irradiation mirror 13, the mirror 22 rotates around a rotational axis along the Y-axis direction when driving the motor 40 which will be described later.

The detection side lens 23 is configured to narrow the light arriving from the scanning range.

The detection side return mirror 24 is configured to change the travel direction of the light.

The light receiving element is disposed in the lower part of the detection side return mirror 24.

The detection side return mirror 24 is disposed such that direction of the light path is changed downward by approximately 90 degrees to allow the light being incident via the detection side lens 23 to reach the light receiving element 21.

The detection side lens 23 is disposed between the detection mirror 22 and the detection side return mirror 24. The detection side lens 23 is configured to narrow the aperture of the light beam being incident on the light receiving lens 21 to be approximately an element width of the APD.

The detection unit 20 operates in the following manner to detect reflected waves from the object. The reflected waves from an object located in a predetermined direction depending on the rotational angle of the detection mirror 22, that is, an emission direction of the light from the irradiation mirror 13, pass through the transmission window 81 of the housing and are incident on the detection mirror 22. The reflected waves are reflected at the detection mirror and then detected by the light receiving element 21 via the detection side lens 23 and the detection side return mirror 24.

[2-3. Intermediate Plate and Motor]

The intermediate plate 30 is provided between the irradiation mirror 13 and the detection mirror 22, extending in the horizontal direction and having a circular shape and plate-like shape. The intermediate plate 30 together with a shielding plate 83 which will be described later serves as a dividing plate that divides a region inside the housing 6 into an installation space 6a where the irradiation unit 10 is disposed and an installation space 6b where the detection unit 20 is disposed.

The irradiation mirror 13 together with the detection mirror 22 are referred to as a mirror module 3. The mirror module 3 and the intermediate plate 30 are configured to be integrated with each other.

The motor 40 is disposed below the mirror module 3 and causing the mirror module 3 and the intermediate plate 30 to rotate around the rotational axis along the Y-axis direction.

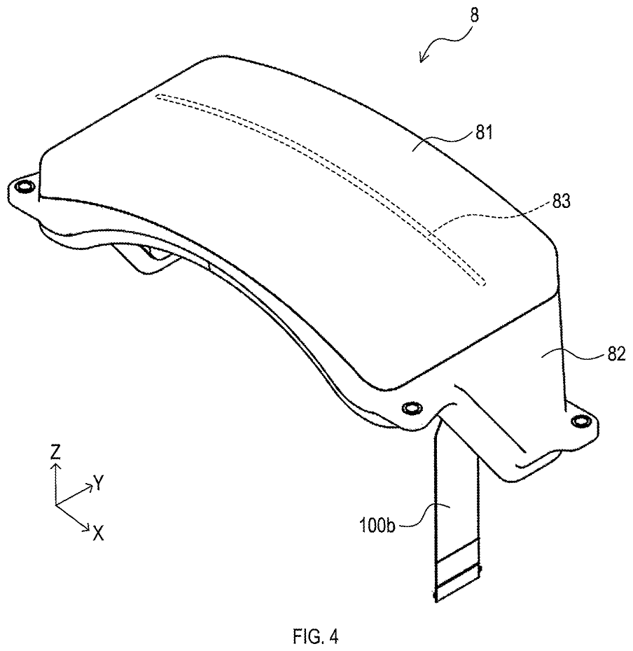

### 3. Configuration of Cover

[3-1. Overall Configuration of Cover] As shown in FIGS. 1 and 4, the cover 8 includes the transmission window 81, a frame 82 and a shielding plate 83 provided on the inner surface of the transmission window 81.

As described above, the transmission window 81 is a portion in the cover 8 facing the detection module 2, where the light of the transmission waves and the light of the reflected waves pass through. The transmission window 81 is formed in a convex-curved shape towards outside the housing 6. Specifically, the transmission window 81 is formed to have a shape in which substantially rectangular-plate-shaped member is bent such that a center portion thereof in the X-axis direction has the greatest convexity.

The frame 82 has a frame-shaped body extending from an outer periphery of the transmission window 81 towards the rear side thereof.

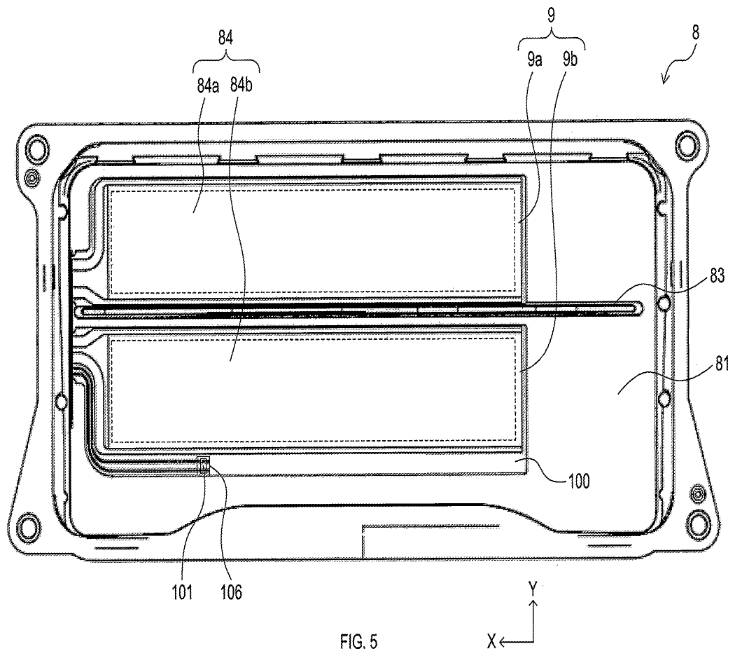

As shown in FIGS. 2 to 4, the shielding plate 83 is a plate-like member provided to be along the X-axis direction, protruding from the inner surface of the transmission window 81. As shown in FIG. 5, the shielding member 83 is provided on the inner surface of the transmission window 81 in a region upper than the center portion with respect to the Y-axis direction.

Further, as shown in FIG. 3, the shielding plate 83 together with the intermediate plate 30 serves as a dividing plate that divides the region inside the housing 6 into the installation space 6a of the irradiation unit 10 and the installation space 6b of the detection unit 20. Specifically, the shielding plate 83 and the intermediate plate 30 divides a space between the mirror module 3 provided with the irradiation mirror 13 and the detection mirror 22 and the transmission window 81 into the irradiation unit 10 side and the detection unit 20 side. In other words, the shielding plate 83 and the intermediate plate 30 separates a space where the light emitted from the light sources 11 and 12 and eventually deflected by the irradiation mirror 13 passes through towards the transmission window 81 and a space where the reflected waves being incident from the transmission window 81 directly passes through before being deflected by the detection mirror 22. As shown in FIG. 2, the shielding plate 83 has a shape that occupies a gap between the intermediate plate 30 and the transmission window 81, and has a shape in which an outline of the shielding plate 83 in the intermediate plate 30 side is along the outer periphery of the intermediate plate 30. A small gap is provided between the shielding plate 83 and the intermediate plate 30 to allow the intermediate plate to rotate in response to the rotation of the motor 40.

The shielding plate 83 and the intermediate plate 30 are each formed of resin material which prevents the laser light emitted from the light sources 11 and 12 from transmitting therethrough such that the light of the transmission waves which are diffusely reflected in the installation space 6a of the irradiation unit 10 inside the housing is suppressed from being incident into the installation space 6b of the detection unit 20. Hence, the diffusively reflected light of the transmission waves is unlikely to be erroneously detected by the detection unit 20, thereby improving the ranging accuracy.

[3-2. Configuration of Inside the Cover]

As shown in FIG. 5, a heater 9 for heating the transmission window 81 and a circuit component 101 used for the LIDAR apparatus 1 are provided on the inner surface of the transmission window 81. The circuit component 101 is, specifically, circuit components that constitute a part of the circuit used for controlling the auxiliary equipment attached to the LIDAR apparatus 1.

The auxiliary equipment attached to the LIDAR apparatus 1 is configured to assist the ranging of the LIDAR apparatus 1 as an auxiliary equipment other than the detection module 2 which is necessary for ranging of the LIDAR apparatus 1. The auxiliary equipment is operated by electrical control. According to the present embodiment, the auxiliary equipment is a heater 9.

Further, the circuit component 101 constitutes at least a part of circuit used for controlling the heater 9. According to the present embodiment, the circuit component 101 is a temperature sensor that detects a temperature of the transmission window 81 used for controlling the temperature of the heater 9.

As shown in FIG. 5, the heater 9 is provided with an irradiation side heater 9a disposed in a region facing the installation space 6a of the irradiation unit 10, and a detection side hear 9b disposed in a region facing the installation space 6b of the detection unit 20, on the inner surface of the transmission window 81.

The heater 9 is disposed on the inner surface of the transmission window 81 to cover the transmission region 84 where at least either the transmission waves or the reflected waves to be detected by the detection unit 20 pass through. Specifically, the heater 9 is disposed in the following manner.

The transmission region 84 is provided with a transmission wave transmissive region 84a through which the transmission waves are transmitted, and a reflected wave transmissive region 84b through which the reflected waves to be detected by the detection unit 20 are transmitted. Specifically, the transmission wave transmissive region 84a is a region inside the transmission window 81, where the light of the transmission waves emitted towards the scanning range are directly transmitted therethrough. Specifically, the reflected wave transmissive region 84b is, in the case where an object is present at any location within the scanning range, a region inside the transmission window 81, where the reflected waves as the object to be detected by the detection unit 20 are transmitted therethrough.

The irradiation side heater 9a id disposed to cover the transmission wave transmissive region 84a. The detection side heater 9b is disposed to cover the reflected wave transmission region 84b.

Note that the transmission region 84 is positioned inside the transmission window 81 to be offset towards an upper right portion when viewed from the front side of the transmission window 81 (i.e. upper left portion when viewed from inside the transmission window 81).

On the other hand, as shown in FIG. 5, the circuit component 101 is disposed on the inner surface of the transmission window 81 in a region other than a region where the heater 9 is disposed. Also, the circuit component 101 is disposed inside the transmission window 81, in a region facing the installation space 6b of the detection unit 20, that is, a region under the shielding plate 83.

[3-3. Film Substrate]

The above-described heater 9 is formed on the film substrate 10 attached to the inner surface of the transmission window 81.

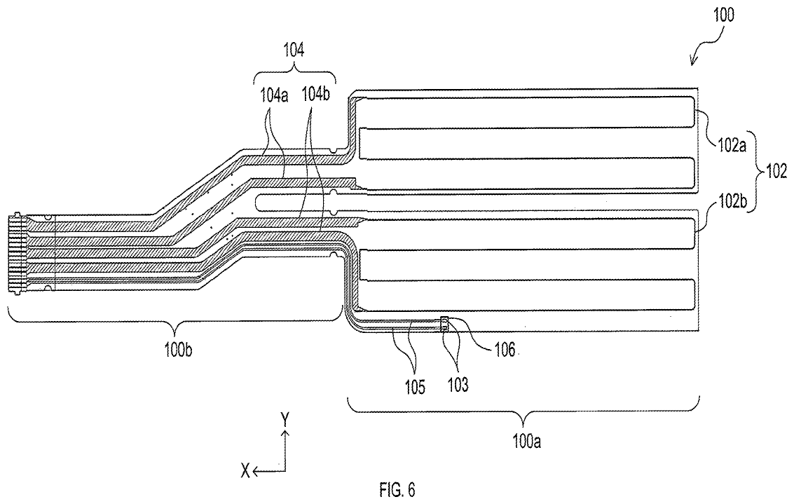

As shown in FIG. 6, the film substrate 100 is a printed circuit board in which various wiring patterns are formed on a film-shaped insulated substrate.

The film substrate 100 is provided with a film substrate body 100a attached to the inner surface of the transmission window 81, and a wiring portion 100b which is bent at an end portion of the inner surface of the transmission window 81, extending in the rear side of the housing 6. For the wiring portion 100b, the width in the Y-axis direction is narrower than that of the film substrate body 100a.

In the film substrate body 100a, a pattern 102 of a heater line constituting the heater 9 (hereinafter referred to as heater pattern 102) and a land 103 for mounting the circuit component 101 are formed. In the wiring portion 100b, a wiring pattern 104 extending to the heater line (hereinafter referred to as heater wiring pattern 104) and a wiring pattern 105 extending to the circuit component 101 (hereinafter referred to as circuit component wiring pattern 105) are formed. The heater wiring pattern 104 is connected to the heater pattern 102 at a boundary portion between the film substrate body 100a and the wiring portion 100b. The circuit component wiring pattern 105 extends to the film substrate body 100a from the wiring portion 100b, and is connected to the land 103 for mounting the circuit component 101.

These patterns and the land 103 are formed by laminating conductive layers on the surface of the film-shaped insulation substrate and etching the conductive layers. As a conductor material, copper may preferably be used.

The heater pattern 102 is provided with an irradiation side heater pattern 102a that constitutes the irradiation side heater 9a and a detection side heater pattern 102b that constitutes the detection side heater 9b. The film substrate body 100a is divided into an upper part and a lower part thereof by forming a gap between the irradiation side heater pattern 102a and the detection side heater pattern 102b. In the gap, when the film substrate body 100a is attached to the inner surface of the transmission window 81, the shielding plate 83 is positioned.

The heater wiring pattern 104 is provided with an irradiation side wiring pattern 104a connected to the irradiation side heater pattern 102a and a detection side wiring pattern 104b connected to the detection side heater pattern 102b.

The outermost surface of the film substrate is covered by a resin film having an insulation property to protect these patterns. An opening 106 is formed in a part of the resin film and the land 103 is exposed from the opening 106. For the land 103, a Ni plating and a gold plating or the like are applied on the conductive layer, thereby protecting the land 103. The circuit component 101 is soldered to the land 103 of the film substrate 100 via the opening 106. As shown in FIGS. 5 and 6, the circuit component 101 and the land 103 are arranged inside the transmission window 81 to be offset towards the end portion where the wiring portion 100b is bent, that is, offset towards the left side when viewing the transmission window 81 from inside thereof.

### 4. Effects and Advantages

According to the above-described embodiment, the following effects and advantages can be obtained.

(4a) According to the above-described LIDAR apparatus 1, the heater 9 is disposed on the inner surface of the transmission window 81 so as to cover the transmission region 84 where at least either the transmission waves or the reflected waves to be detected by the detection unit 20 pass through. The circuit component 101 is disposed in a region inside the transmission window 81, other than a region where the heater 9 is disposed. Since the circuit component is disposed in this manner, an available space other than the region where the heater 9 is disposed inside the transmission window 81 can be effectively utilized.

(4b) In the case where the circuit component 101 is disposed in a region facing the installation space 6a of the irradiation unit 10 in the transmission window 81, when the light of the transmission waves which are partly reflected at the transmission window 81 falls on the circuit component 101, the light of the transmission waves may be diffusely reflected. As a result, the diffusely reflected light of the transmission waves is likely to be erroneously detected by the detection unit 20, thereby lowering the ranging accuracy.

According to the above-described LIDAR apparatus 1, the circuit component 101 is disposed in a region facing the installation space 6b of the detection unit 20 in the transmission window 81. Hence, compared to a case where the circuit component is disposed in a region facing the installation space 6a of the irradiation unit 10 in the transmission window 81, diffuse reflection inside the installation space 6a of the irradiation unit 10 is suppressed, thereby improving the ranging accuracy.

(4c) According to the above-described LIDAR apparatus 1, the film substrate on which the heater pattern 102 and the circuit component wiring pattern 105 are formed, is disposed on the inner surface of the transmission window 81. Hence, in the LIDAR apparatus 1 where the heater 9 is provided, the circuit component wiring pattern 105 can be formed in a process as same as the process of forming the heater pattern 102, and the circuit component 101 can readily be disposed in an available space in the transmission window 81.

(4d) According to the above-described LIDAR apparatus 1, the heater wiring pattern 104 and the circuit component wiring pattern 105 are formed, and the wiring portion 100b of the film substrate 100 is bent at an end portion of the inner surface of the transmission window 81, extending in the rear side of the housing 6. The circuit component 101 is disposed on the inner surface of the transmission window close to the end portion where the wiring portion 100b of the film substrate 100 is bent. Hence, the length of the circuit component wiring pattern 105 can be shorter.

(4e) According to the above-described LIDAR apparatus 1, the transmission region 84 is positioned inside the transmission window 81 to be offset towards upper side and left side when viewed from the front side of the transmission window 81. The transmission region 84 is provided inside the transmission window 81 at an offset position, whereby a large available space inside the transmission window 81 can be secured.

### 5. Other Embodiments

The embodiment of the present disclosure is described so far. The present disclosure is not limited to the above-described embodiment and may be modified in various manners.

(5a) According to the above-described embodiment, the circuit component 101 is a temperature sensor but the circuit component 101 is not limited thereto. For example, in the case where a circuit for detecting the temperature of the transmission window 81 requires auxiliary components such as a capacitor and a resistor, these components may be included in the circuit component 101. Also, according to the above-described embodiment, the circuit component 101 constitutes a circuit that detects the temperature of the transmission window 81. However, the circuit constituted by the circuit component 101 is not limited thereto. The circuit constituted by the circuit component 101 may be a control circuit that controls the heater 9 to be ON and OFF.

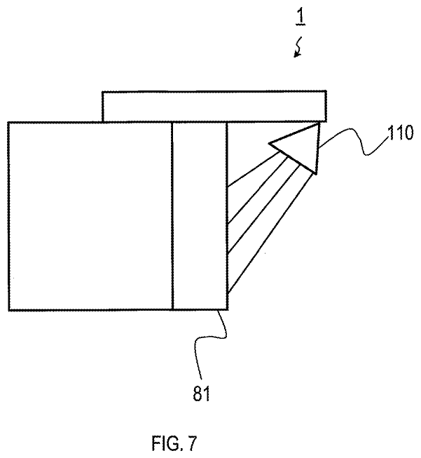

(5b) According to the above-described embodiment, an auxiliary equipment attached to the LIDAR apparatus 1 is the heater 9, but the auxiliary equipment is not limited to thereto. For example, the auxiliary equipment may be cleaning equipment that cleans the transmission window 81. The cleaning equipment cleans dirt from the transmission window 81 to keep the transmission window 81 clean, thereby suppressing diffuse reflection of the transmission waves and reflected waves due to dirt adhered to the transmission window 81 and improving the ranging accuracy. Further, the cleaning equipment is controlled to operate depending on environment of the surroundings, state of dirt on the transmission window 81 or the like. As the cleaning equipment, as shown in FIG. 7, a washer 110 can be used for washing an outside surface of the transmission window 81 with a cleaning liquid. As another cleaning equipment other than the above-described cleaning equipment, a wiper for wiping dirt on the transmission window 81, or an ultrasonic vibrator device that blows dirt adhered to the transmission window 81 can be used.

(5c) According to the above-described embodiment, the circuit component 101 constitutes a part of the circuit used for controlling the auxiliary equipment attached to the LIDAR apparatus 1. However, the circuit component 101 is not limited thereto. For example, the circuit component 101 may constitute a circuit used for measuring a distance to an object. As the circuit for measuring the distance to the object, for example, a control circuit for controlling the irradiation unit 10, and a distance calculation circuit that process a signal of the reflected waves detected at the detection unit 20 and calculates the distance to the object. For a specific circuit component 101, various electronic components to be mounted on electronic circuit board such as a microcomputer, a capacitor and the like may be used.

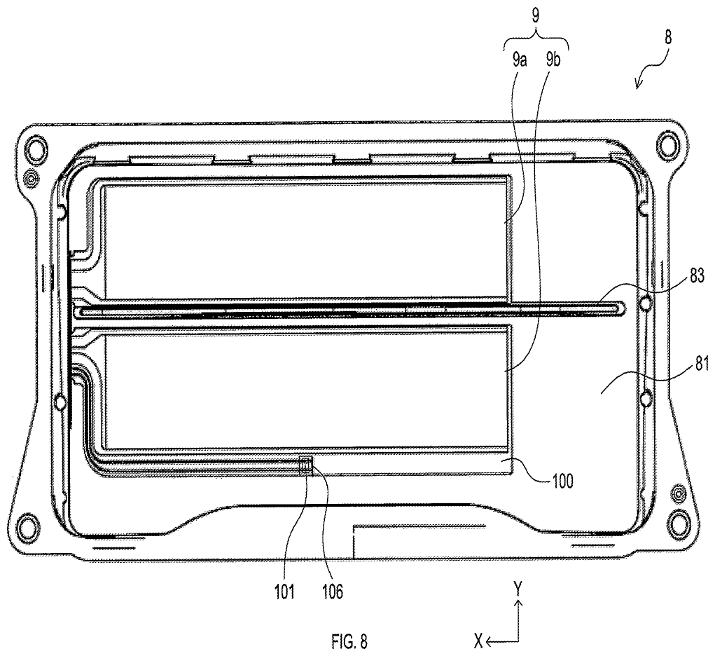

(5d) According to the above-described embodiment, the circuit component 101 is disposed on the inner surface of the transmission window 81 to be offset towards the end portion where the wiring portion 100b is bent, that is, offset towards the left side when viewing the transmission window 81 from inside thereof. However, the position where the circuit component 101 is disposed is not limited thereto. For example, as shown in FIG. 8, the circuit component 101 may be disposed in a center region of the transmission window 81 with respect to the scanning direction (i.e. left-right direction when viewing the transmission window 81 from front side). The transmission window 81 is formed in a convex-curved shape towards outside the housing 6, in which the curvature of the center region with respect to the scanning direction of the transmission window 81 is smaller than the curvature of a region in the end portion side with respect to the scanning direction. In other words, the center region of the transmission window 81 is formed to be flat compared to a region in the end portion side. Hence, the center region of the transmission window 81 is suitable for mounting the circuit component 101 compared to that of the end portion side region.

(5e) According to the above-described embodiment, the heater 9 and the circuit component 101 are provided on the inner surface of the transmission window 81, but they may be provided on the outer surface of the transmission window 81.

(5f) According to the above-described embodiment, as the range finding apparatus, the LIDAR apparatus 1 is exemplified. However, the type of range finding apparatus may be a millimeter-wave radar apparatus, or an ultrasonic sensor apparatus.

(5g) According to the above-described embodiment, the LIDAR apparatus 1 is mounted on a front side of the vehicle. However, the mounting position of the LIDAR apparatus to the vehicle is not limited thereto. For example, the LIDAR apparatus 1 may be mounted on a lateral side, a rear side or the like of the vehicle.

(5h) Multiple functions of a single component in the above-described embodiment may be divided into a plurality of components, and functions included in a plurality of components may be integrated to a single component. Further, some of the configurations of the above-described embodiment may be omitted. In addition, at least some of the configurations of the above-described embodiment may be added to or replaced with the configurations of the other embodiments described above.

### CONCLUSION

One aspect of the present disclosure provides a range finding apparatus effectively utilizing an available space of a transmission window in the range finding apparatus provided with a heater.

The range finding apparatus according to present disclosure is a range finding apparatus for measuring a distance to an object including a detection module, a housing, a transmission window, a heater and a circuit component. The detection module includes an irradiation unit that irradiates transmission waves scanned in a scanning direction set in advance, and a detection unit that detects reflected waves of an object arriving from a scanning range. The housing accommodates the detection module. The transmission window is a part of the housing and provided facing the detection module, allowing the transmission waves and the reflected waves to transmit therethrough. The heater heats the transmission window. The circuit component is used for the range finding apparatus. The heater is disposed on an inner surface or an outer surface of the transmission window to cover a transmission region where at least either the transmission waves or the reflected waves to be detected by the detection unit pass through. The circuit component is disposed on the inner surface or the outer surface of the transmission window, in a region other than a region where the heater is disposed.

According to this configuration, an available space of the transmission window can be effectively utilized in the range finding apparatus provided with a heater.

What is claimed is:

1. A range finding apparatus for measuring a distance to an object comprising:
a detection module including an irradiation unit that irradiates transmission waves scanned in a scanning direction set in advance, and a detection unit that detects reflected waves of an object arriving from a scanning range;
a housing that accommodates the detection module;
a transmission window as a part of the housing provided facing the detection module, allowing the transmission waves and the reflected waves to transmit therethrough;
a heater that heats the transmission window; and
a circuit component used for the range finding apparatus, wherein
the heater is disposed on an inner surface or an outer surface of the transmission window to cover a transmission region where at least either the transmission waves or the reflected waves to be detected by the detection unit pass through; and
the circuit component is disposed on the inner surface or the outer surface of the transmission window, in a region other than a region where the heater is disposed.

2. The range finding apparatus according to claim 1 further comprising a dividing plate that that divides a region into an installation space where the irradiation unit is disposed and an installation space where the detection unit is disposed.

3. The range finding apparatus according to claim 1 further comprising a film substrate on which a pattern of a heater line constituting the heater and a wiring pattern extending to the circuit component are formed; and
the film substrate is provided on the transmission window.

4. The range finding apparatus according to claim 3, wherein the film substrate is provided on the inner surface of the transmission window;
a part of the film substrate, on which a pattern of a heater line constituting the heater and a wiring pattern extending to the circuit component are formed, is bent at an end portion of the inner surface of the transmission window, and extends in a rear side of the housing where a front side is defined as a side where the transmission window is provided in the housing;
and
the circuit component is disposed on the inner surface of the transmission window close to the end portion where the part of the film substrate is bent.

5. The range finding apparatus according to claim 1, wherein
the transmission window is formed in a convex-curved shape towards outside the housing;
a curvature of a center region of the transmission window with respect to the scanning direction is smaller than a curvature of a region in an end portion side with respect to the scanning direction; and
the circuit component is formed in the center region of the transmission window with respect to the scanning direction.

6. The range finding apparatus according to claim 1, wherein
the circuit component constitutes a part of a circuit used for controlling an auxiliary equipment attached to the range finding apparatus.

7. The range finding apparatus according to claim 6, wherein
the auxiliary equipment is the heater.

8. The range finding apparatus according to claim 7, wherein
the circuit component is a temperature sensor that detects a temperature of the transmission window.

9. The range finding apparatus according to claim 1, wherein
the circuit component constitutes at least a part of a circuit used for measuring a distance to the object.
